(19) United States
(12) Patent Application Publication
(10) Pub. No.: US 2008/0231430 A1
(43) Pub. Date: Sep. 25, 2008

(54) Smoke Alarm Test Reminder Device

(76) Inventors: Bruce Edward Butler, Maple Ridge (CA); Mary Daly, Maple Ridge (CA)

Correspondence Address: Bruce Butler, 22123 126th Ave, Maple Ridge, BC, V2X 0V8, CA

(21) Appl. No.: 11/690,819

(22) Filed: Mar. 24, 2007

(51) Int. Cl. G08B 1/00

(52) U.S. Cl. 340/309.7; 340/628

(57) ABSTRACT

A small, self-contained device that regularly reminds people to test their smoke alarms is provided. This reminder device has internal electronics with a power supply, and includes an electronic timer that periodically activates a visual reminder indicator (2) (or optional internal audible indicator). A manual reset is provided to restart the timer and to deactivate the indicator. Additionally, an audio detection circuit is provided which automatically resets the timer and deactivates the indicator when the reminder device is held in close proximity to a smoke alarm that is being tested. The reminder device is self-contained in a housing with a decorative front bezel (14) and has attachment means by which the device can be attached to many different items within a household.

### CROSS REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention relates in general to electronic reminder timers and in particular to an inexpensive reminder device so people will regularly test and inspect their home smoke alarms.

US Patent Classification: 340/309.7, 340/628, 340/514, 340/693.5, 368/107, 368/108

### BACKGROUND OF THE INVENTION

The advantages of having one or more working smoke alarms in a home are well documented. Countless lives are saved every year by working smoke alarms, because people are able to escape from a fire when given adequate warning. However, many lives are lost every year due to fire in homes equipped with smoke alarms, because those smoke alarms did not work when needed. That is evidence that many people never test their smoke alarms or, if they do, they do so rarely.

According to statistics from the National Fire Protection Association (www.nfpa.org) and the US Fire Administration (www.usfa.dhs.gov):
There are 3,000-5,000 civilian fatalities due to fires in the US every year.
There are 15,000-20,000 civilian injuries due to fires in the US every year.
Approx. 80% of fire deaths occur in the home.
Approximately 20-30% of smoke alarms in homes do not work.

There is also strong evidence to suggest that when people, especially children, take part in the monthly testing of smoke alarms, they are more likely to associate the smoke alarm sound with the smoke alarm itself. This increases the likelihood that they will respond positively to the smoke alarm when a real fire occurs.

All agencies in Canada and the United States that are tasked with educating the public about fire safety support the NFPA recommendation that residential smoke alarms be tested and inspected once per month. All smoke alarms advertised or sold in Canada must meet specifications developed by the Underwriter's Laboratory of Canada (ULC). In the US, similar specifications are developed by the NFPA and by the Underwriter's Laboratory. Every smoke alarm now sold in North America has a test button that, when pressed, causes its alarm to sound. These alarm tones must meet strict specifications for frequency, repetition rate and sound pressure level (i.e. ‘loudness’).

Given the statistics presented above, it is apparent that if more residential smoke alarms were tested regularly, there would likely be fewer fatalities and injuries due to fires (assuming that non-working smoke alarms were made to work again). It is also apparent that people are not testing their smoke alarms regularly. Presently, there is no device available whose sole purpose is to remind people to regularly test and inspect their smoke alarms.

### DESCRIPTION OF THE PRIOR ART

U.S. Pat. No. 5,568,129 (Sisselman, October 96) describes an alarm device including a self-test reminder circuit. There are two significant drawbacks to that device. First, since the reminder circuit in that device is integral to the alarm device, the reminder circuit will not perform its function if the device malfunctions or loses all electrical power (including battery power). As the statistics presented earlier show, a significant percentage of smoke alarms fail to work—and the purpose of testing smoke alarms is to identify those that do not work. Integrating the reminder circuit into a smoke alarm that has dead batteries or is defective defeats the purpose of the reminder circuit. Second, since most smoke alarms are mounted to ceilings, high up on walls, or in other out-of-the-way locations, it is less likely that the device's reminder indicators would be seen or heard.

### BRIEF SUMMARY OF THE INVENTION

This invention provides a novel reminder device whose sole purpose is to remind people to inspect and test their smoke alarms regularly. This reminder device is self-contained and compact, so it can easily be mounted in many possible locations and on many different surfaces. This reminder device utilizes a visual indicator to provide the reminder, but an optional audible indicator can also be used. To increase the probability that its indicator(s) will be seen/heard, such a reminder device must be situated in a well-traveled area of the house. Since one of the most highly traveled areas in a house is the kitchen, the preferred embodiment for this reminder device is a ‘fridge magnet’ assembly. However, many other packaging and mounting configurations are also possible, and the reminder device may be packaged within or as part of another device or object that performs a completely different purpose.

The reminder device's operation is very simple. At regular time intervals (typically 30 days, as recommended by the NFPA), the device's internal timer expires, and its visual and/or audible indicators activate. This provides the reminder to test and inspect all smoke alarms. The user then manually resets the device, which deactivates the indicator(s) and restarts the timer for another reminder interval.

To encourage children to take part in the monthly testing of smoke alarms, this reminder device optionally includes an ‘audio reset’ feature. This optional feature consists of an audio detection circuit that will automatically reset the device when it detects the alarm tones from a smoke alarm that is being tested. The general idea is that, once the indicator(s) on the reminder device activate, the child sees or hears them and reminds an adult it is time to test the smoke alarms. The child is encouraged to assist the adult by holding the reminder device up close to the first smoke alarm while the adult presses the smoke alarm's test button. When the reminder device detects the alarm tones from the smoke alarm, it resets itself, and its indicator(s) turn off. All remaining smoke alarms should then also be tested and inspected.

The reminder device is primarily intended to be powered by a DC battery, and its circuitry is simple enough that it can be designed using very low-power electronics and a high capacity battery in order to maximize the time between battery replacements. Depending on the packaging, the reminder device could also be powered by AC voltage with a DC battery backup.

### BRIEF DESCRIPTION OF THE DRAWINGS

FIG. 1 shows a front plan view of the preferred embodiment of the invention, namely packaged as a ‘fridge magnet’ assembly.

FIG. 2 shows a side view of the preferred embodiment of the invention, namely packaged as a ‘fridge magnet’ assembly.

FIG. 3 shows a rear plan view of the preferred embodiment of the invention, namely packaged as a ‘fridge magnet’ assembly.

FIG. 4 is an electronic block diagram for the preferred embodiment of the invention.

FIG. 5 is an electronic block diagram showing one possible embodiment of the timer of FIG. 4.

FIG. 6 is an electronic block diagram showing one possible embodiment of the audio detector of FIG. 4.

### DETAILED DESCRIPTION OF THE INVENTION

FIG. 4 provides a functional block diagram for the preferred embodiment of the reminder device. When power is applied to the device, the timer 1 is activated. When the timer expires (typically 30 days), its latched output activates the visual indicator 2 and/or the optional audible indicator 3, and enables the optional audio detector 4. In this embodiment, the visual indicator 2 is a flashing bright LED. The optional audible indicator 3 could be a piezoelectric buzzer, beeper or other similar component.

Once enabled, the optional audio detector 4 samples the audio input signal from the audio transducer 5. When this detector detects alarm tones from a smoke alarm being tested, it generates a reset signal. This reset signal resets the timer 1, which in turn causes the optional audio detector 4 to be disabled. The momentary pushbutton 6 provides for a manual reset of the reminder device for situations where:
The user does not wish to utilize the audio reset feature, or
The device is not manufactured with the optional audio detector.

The preferred embodiment of the voltage source 7 is a simple DC battery. This battery provides enough electrical power to operate the device for an extended period of time (e.g. one year or more). Since battery-powered smoke alarms are now available that will operate for 10 years from a single battery, it would be advantageous for this device to be able to run for 10 years from a single battery as well.

An alternate embodiment of the voltage source 7 is an AC-to-DC power supply that also recharges a DC battery. This embodiment would be used when the reminder device is packaged as part of another device that is AC powered. The rechargeable DC battery would power the reminder device during periods when AC power is lost, thus retaining the timer's state.

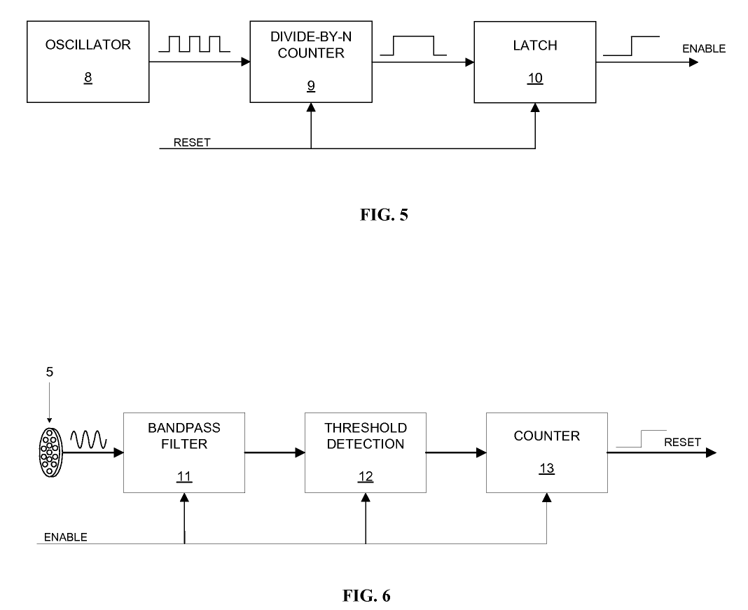

FIG. 5 provides details on one possible embodiment of the timer 1, using standard digital logic components. The output from oscillator 8 is fed into a divide-by-N counter 9 to extend the oscillator's period to the reminder interval (typically 30 days). When this counter counts up to the reminder interval, its output is fed into latch 10. The output of latch 10 becomes the enable signal that activates visual and/or audible indicators (2 and 3). Counter 9 and latch 10 are reset by the reset signal provided by the manual reset button 6 or audio detector 4. Oscillator 8 could be a standard 555 timer configured to run in a stable mode.

Many combinations of oscillator frequency and divide-by-N counter size are possible to provide the desired reminder interval (typically 30 days). If the ‘N-size’ needed is larger than is available on a single counter, multiple divide-by-N counters can be cascaded together. The following table describes several possible combinations of oscillator and counter N-size. This table is based on 2,590,000 seconds in a month (60 sec/min×60 min/hour×24 hours/day×30 days/month). Since binary divide-by-N counters are very common, the last column in this table shows the approximate number of bits needed to realize each N-size.

| Oscillator | | | |
|---|---|---|---|
| Frequency | Oscillator | | Size of binary counter |
| (Hz) | Period (sec) | N-size | (bits) |
| 10 | 0.1 | 25,900,000 | 24-25 |
| 1 | 1 | 2,590,000 | 21-22 |
| 0.1 | 10 | 259,000 | 18 |

FIG. 6 provides a functional description of the optional audio detector, which, in a preferred embodiment, is only enabled after the reminder period has expired. The input signal from the piezoelectric audio transducer 5 is sampled using three different stages:
1. A bandpass filter 11, with lower and upper cut-off frequencies set to those used by smoke alarms manufactured in North America (approx. 3000-4000 Hz). This filter reduces the possibility that the device will reset due to audio signals from other devices commonly found in the home.
2. A threshold detector 12. The Underwriters Laboratory (UL) voluntary standard, UL 217—Single and Multiple Station Smoke Alarms, specifies that a smoke alarm must emit an alarm signal with an A-weighted sound pressure level of at least 85 decibels (dBA) at a distance of 10 feet. This threshold detector is designed to only pass an audio signal with at least this sound pressure level [implying that the user must hold the reminder device within approximately 10 feet of the smoke alarm being tested].
3. A counter 13. This counter ensures that multiple alarm tones are received from a smoke alarm being tested, with the counter limit set to some small integer value (but greater than 1).

The bandpass filter 11 could be realized with a circuit as simple as a first-order Butterworth bandpass filter circuit. Such a circuit would require only a single resistor, capacitor and inductor. The threshold detector 12 can be realized by selecting an audio transducer with an appropriate sensitivity rating, wherein the transducer's output voltage will only trigger the counter 13 when the reminder device is held close to the smoke alarm being tested. The counter 13 could be realized using a single divide-by-N counter.

There are two important advantages in having this optional audio detector only enabled after the reminder period has expired:
False resets are eliminated since the detector cannot possibly reset the reminder device until after the reminder period has expired, and,
It will not draw any current until after the reminder period has expired (extending the life of the battery).

It is noted that the reminder device can still provide regular reminders if the optional audio detector is not included—only the audio reset feature would not be available. It is also noted that, while FIG. 6 shows these three stages in a serial configuration for conceptual purposes, any other combination or embodiment of these stages could be realized. The important concept is that having one or more of these three stages greatly increase the chances that the reminder device will only reset when held close to a real smoke alarm is being tested.

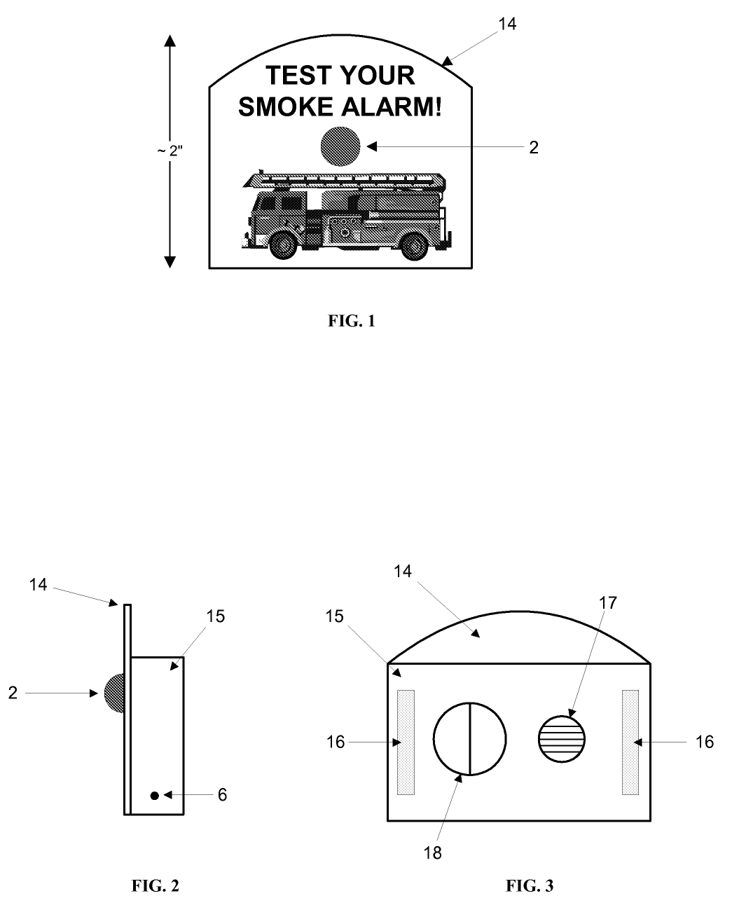

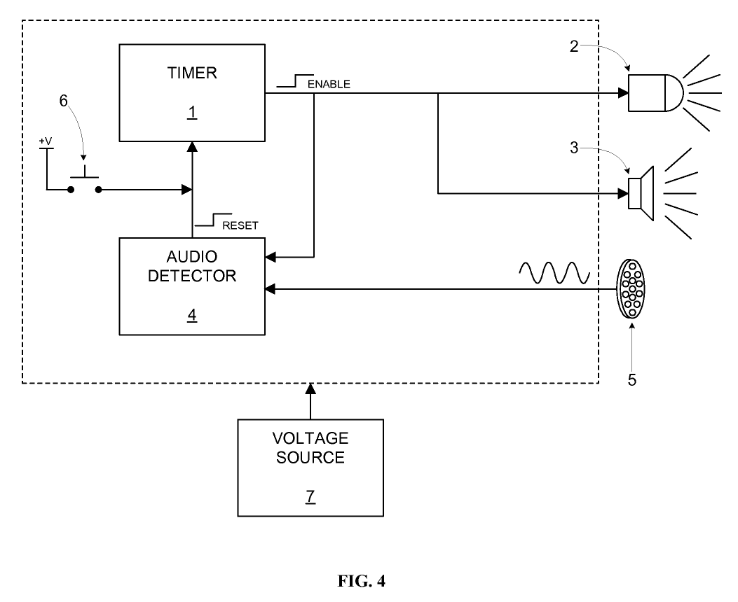

FIGS. 1, 2 and 3 shows the front, side and rear views of the preferred embodiment of the reminder device, i.e. packaged as a battery-powered ‘fridge magnet’ reminder with a visual indicator. A bezel 14 is attached to the front of the device housing 15, which houses all of the device's components. The bezel has a colorful ‘reminder’ graphic and an opening for the visual indicator 2 (a flashing LED in this embodiment). Internal to the device housing, all components are mounted on a single circuit board.

The manual reset button 6 is accessible through the side of the housing 15. This button is recessed to avoid unintended resets when handling the device. A pencil or other similar pointed implement can be used to press the reset button.

One or more magnets 16 are mounted on the rear of the device to hold it firmly to the fridge door. The static magnetic field from these small magnets does not affect the operation of the device when standard components are used to realize all the circuitry in this reminder device.

An opening 17 in the rear of the housing 15 provides a sound path from the smoke alarm being tested to the internal audio transducer 5. When the device is removed from its mounting location, it is held with its rear facing the smoke alarm being tested. This provides a clear sound path from the smoke alarm to the audio transducer, as well as positioning the indicator towards the user (so he can see when the device has reset).

An access port 18 is provided for access to the internal battery.

What is claimed is:

1. A smoke alarm test reminder device comprising:
a timer;
one or more reminder indicators;
a manual reset control;
a voltage source;
a housing; and
an optional audio detector.

2. The smoke alarm test reminder device of claim 1, wherein said timer, after being powered up or reset, expires once the reminder period has elapsed, then activates said reminder indicators.

3. The timer of claim 2, wherein said timer, when it expires, activates the optional audio detector.

4. The smoke alarm test reminder device of claim 1, wherein said indicators provide the visual and/or audible reminder that it is time to test and inspect all smoke alarms.

5. The smoke alarm test reminder device of claim 1, wherein said manual reset control, when activated, causes said timer to reset and said reminder indicator(s) to be deactivated.

6. The manual reset control of claim 5, wherein said control, when activated, causes the optional audio detector to be deactivated.

7. The smoke alarm test reminder device of claim 1, wherein said voltage source consists of either: a DC battery; or an external AC voltage source converted to DC.

8. The smoke alarm test reminder device of claim 1, wherein said housing: has a decorative front bezel and one or more magnets, fasteners, clips or other attachments so that the device can be mounted in a variety of well-traveled locations within a household; or is part of another device or object that performs a completely different purpose from said reminder device, excluding an alarm device as defined in U.S. Pat. No. 5,568,129 (Sisselman, October 96).

9. The smoke alarm test reminder device of claim 1, wherein said optional audio detector detects the alarm tones from a smoke alarm being tested, the detection of those tones being based on one or more of the following criteria:
tones are in the frequency band used by certified smoke alarms; and/or
tones have a signal strength significantly higher than typical ambient noise found in a household; and/or
multiple alarm tones (more than one tone).

10. The optional audio detector of claim 1, wherein when said optional audio detector detects the alarm tones as defined in claim 9, causes:
the timer defined in claim 1 to reset; and
the reminder indicator(s) defined in claim 1 to be deactivated; and
the optional audio detector defined in claim 1 to be deactivated.
